(19) United States
(12) Patent Application Publication
(10) Pub. No.: US 2002/0161603 A1
(43) Pub. Date: Oct. 31, 2002

(54) Interactive publishing system providing content management

(75) Inventor: Rolando L. Gonzales, New York, NY (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: Tanagraphics, Inc.

(21) Appl. No.: 10/123,746

(22) Filed: Apr. 16, 2002

Related U.S. Application Data
(60) Provisional application No. 60/284,078, filed on Apr. 16, 2001.

(51) Int. Cl. G06F 17/60

(52) U.S. Cl. 705/1

(57) ABSTRACT

There is provided a publishing system for managing content of an article. The system enforces privileges of three agents, namely an author, an editor and a publisher. The author is permitted to create the content, and submit the content to the editor. The editor is permitted to edit the content, and selectively return the content to the author, or submit the content to the publisher. The publisher is permitted to selectively reject the content, or approve of the content for publication.

### CROSS-REFERENCE TO RELATED APPLICATIONS

The present application is claiming priority of U.S. Provisional Patent Application Serial No. 60/284, 078, which was filed on Apr. 16, 2001.

### BACKGROUND OF THE INVENTION

1. Field of the Invention

The present invention relates to an interactive publishing system, and more particularly, an interactive publishing system that manages content by enforcing privileges and responsibilities of users in the roles of an author, an editor and a publisher. The system is particularly suited for management of content that may be published on a web site.

2. Description of the Prior Art

There exist a variety of electronic publishing tools for producing documents in hard copy and electronic format. For example, word processors have been commonly available since at least the 1980's. Such tools enable a user to create content in the form of text and graphics in a document, and often allow a user to include features such as graphic animation and sound. Many publishing tools also provide templates that predefine various layouts of the text and images in the document. As such, a user of an appropriate conventional publishing tool can conveniently create and edit a document to include content in almost any desired format and layout.

Some publishing tools are specialized for employment in a particular industry such as newspaper publishing, book publishing, or publishing of advertising banners. Others are particularly suited for generating documents for a particular media environment, such as for posting to a web site on the Internet. A browser-based publishing tool falls into this category.

A typical browser-based publishing tool allows a user to create a document that includes a hyperlink enabling a person viewing the document to navigate from a first point in the document to a second point in the document, or further, to another document. In a case where a first document is being viewed on a web site, the hyperlink may provide a link to a second document on a different web site.

A conventional browser-based tool typically employs hypertext markup language (HTML) to effectuate a link. HTML is used to structure text and multimedia documents and to set up hypertext links between documents. In many cases, the author of the document must write an appropriate command or set of commands using an HTML script. Consequently, a potential author who is not familiar with HTML script is generally precluded from taking advantage of this capability.

Many publishing tasks, particularly those in a commercial environment, involve a publishing team of more than one person. It is not unusual for the publishing team to include an author for creating a document, an editor for reviewing and editing the work of the author, and a publisher for making a final determination as to whether the document should be published. Collectively, the team manages the content of the document, that is, the team determines the nature of and placement of material in the document. This management process can be labor and time intensive as it often involves a movement of the document from one member of the team to another member, and further involves some level of communication, oral and written, between the members.

Typically, each member of the publishing team has certain privileges and responsibilities with regard to the production of the document. Ideally, each of the members should honor the rights and responsibilities of the other members, as conventional wisdom suggests this would tend to yield an end-product of better quality and consistency.

Thus, there is a need for control of the publishing process and, in particular, the enforcement of the privileges and responsibilities of the author, editor and publisher, in order to manage the content of a document. Conventional publishing tools do not appear to have adequately addressed this need.

### SUMMARY OF THE INVENTION

The present invention provides for an interactive publishing system that manages content by enforcing privileges and responsibilities of users in the roles of an author, an editor and a publisher.

A first embodiment of the present invention is a publishing system for managing content of an article. The system includes: a module for permitting an author to (a) create the content, and (b) submit the content to an editor; a module for permitting the editor to (a) edit the content, and (b) selectively (i) return the content to the author, or (ii) submit the content to a publisher; and a module for permitting the publisher to selectively (a) reject the content, or (b) approve of the content for publication. There is also provided a storage media having instructions for controlling a processor in such a system.

A second embodiment of the present invention is a publishing system for managing content of a web page. The system includes: a module for formatting the web page in accordance with a template having a first element and a second element, a module for permitting an author to (a) create a first portion of the content for the first element, and (b) submit the first portion of the content to an editor; a module for permitting the editor to (a) edit the first portion of the content, (b) create a second portion of the content in the second element, and (c) selectively (i) return the first portion of the content to the author, or (ii) submit the first and second portions of the content to a publisher; and a module for permitting the publisher to selectively (a) reject the content, or (b) approve of the content for publication. There is also provided a storage media having instructions for controlling a processor in such a system.

### BRIEF DESCRIPTION OF THE DRAWINGS

FIG. 1 is a block diagram of a computer system suitably configured for employment of the present invention.

FIG. 2 shows a layout of several web pages in accordance with one embodiment of the interactive publishing system of the present invention.

FIGS. 3A and 3B, collectively, illustrate a block diagram of the content management application and a progression of workflow through the interactive publishing system of the present invention.

FIG. 4 is an illustration of an exemplary author workspace.

FIG. 5 shows a set of several exemplary layout templates.

FIG. 6 is an exemplary template form.

FIG. 7 is an illustration of an exemplary editor workspace.

FIG. 8 is an illustration of an exemplary publisher workspace.

FIG. 9 is an illustration of a comment box.

FIG. 10 is an illustration of a template form that includes content in several of its fields.

FIG. 11 is an illustration of an author workspace and shows a technique for a user to create a new right nav.

FIG. 12 is an illustration of a Right Nav workspace.

FIG. 13 is an illustration of a right nav interface.

FIG. 14 is an illustration of an editor workspace and shows a technique for creating a new left nav.

FIG. 15 is an illustration of a Left Nav workspace.

FIG. 16 is an illustration of a left nav template selection page.

FIG. 17 is an illustration of a left nav interface.

### DESCRIPTION OF THE INVENTION

The present invention relates to an interactive publishing system capable of supporting multiple lines of business (LOBs). Although the system may be employed for the publishing of hard copy material, such as a brochure or magazine, it is described herein in the context of a web site, where the term “publish” means to post material to the site, i.e., to “go-live” on the site.

In practice, an LOB can be a department in a company, or it may be regarded as a mini-company within the company. As such, each LOB usually has its own ranking officers and employees, and its own budgetary responsibilities. In the context of the present invention, an LOB is conceptually similar to an LOB in a company, and thus LOBs of the present invention can track a company's LOB organizational structure. However, in the present invention, an LOB or multiple LOBs can be setup regardless of whether a company that employs the present invention is actually organized into LOBs.

“Workflow” refers to a distributed flow or progress of content from creating a work group to content management functions, i.e., (a) creating content, (b) posting the content to a live site, (c) expiring the content, and (d) and archiving the content. Within the workflow there is a set of roles and rules that determine the privileges and responsibilities for each stage in a life cycle of the content.

The publishing system is intended for employment by users that are categorized into one of three roles, namely an Author (creator), an Editor (approver) and a Publisher. Each of the Author, Editor and Publisher has associated privileges and responsibilities that are enforced by the publishing system.

In addition to the Author, Editor and Publisher, there is a fourth role, that of an Administrator. The administrator has an exclusive privilege to create a new LOB and to create a new user within any LOB. The administrator assigns a user name, password, the workflow group and other identifying information. The administrator sets the workflow structure for the LOBs by specifying the number of users and their grouping by type (Author, Editor, Publisher). In the course of assigning a workflow group to a user (typically an Editor) the administrator can designate the user as a Master Editor, a role that has the privilege within an LOB to create a sub-LOB and new subsections within a sub LOB hierarchy. If an LOB does not have Master Editor created sub-LOB, the administrator has a privilege to delete the LOB. The administrator has an exclusive privilege to edit and delete a user role within any LOB.

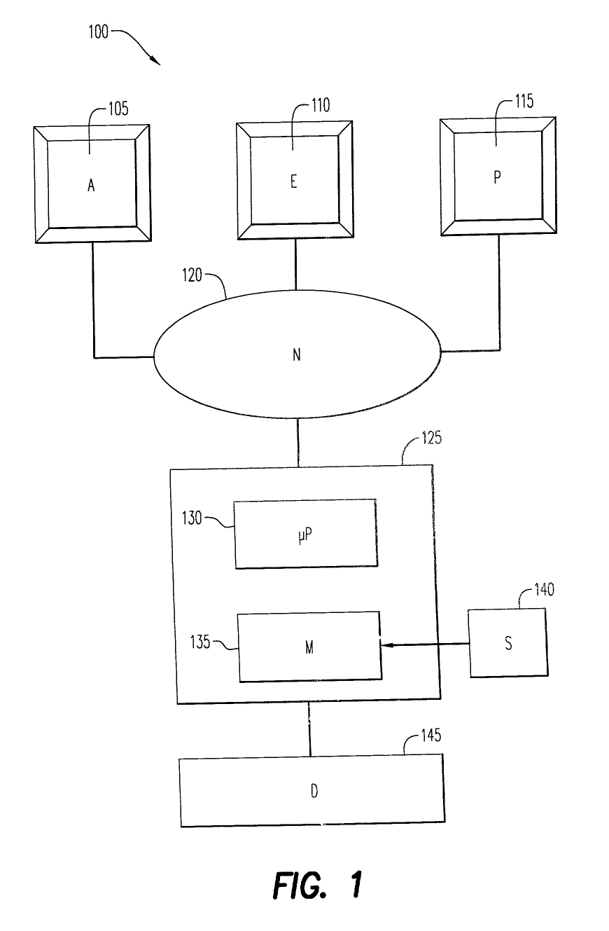

FIG. 1 is a block diagram of a computer system 100 suitably configured for employment of the present invention. The principal components of system 100 are workstations 105, 110, 115, a processing subsystem 125 and a database 145. Workstations 105, 110, 115 are coupled to processing subsystem 125 via a computer network 120.

Computer network 120 can be configured as any conventional network, such as a local area network (LAN), a wide area network (WAN), an extranet, or an intranet. In its preferred embodiment, computer network 120 is the Internet. The Internet includes the World Wide Web, which is regarded as the complete set of documents residing on all Internet servers that use the HTTP (hypertext transfer protocol) protocol, accessible to users via a simple point-and-click system. HTTP is used to request and transmit files, especially web pages, over the Internet or other computer networks.

Workstations 105, 110, 115 are represented as three units, one for each of the users, i.e., the Author, Editor and Publisher. In practice, the workstations need not be dedicated to any particular user, but instead, system 100 may have as few as one workstation that can be shared by the three users, or more than three workstations, any of which can be employed by any user. Workstations 105, 110, 120 may be implemented on a general purpose microcomputer, such as one of the members of the Sun™ Microsystems family of computer systems, one of the members of the IBM™ Personal Computer family, or any conventional workstation or graphics computer device. The workstations each include a display device and a user interface device, such as a mouse, with which the user can point and click to select control points or hot spots from the display device, as is well-known in the art. Whereas the preferred embodiment of network 120 is the Internet, workstations 105, 110, 115 are preferably configured to include a browser capable of accessing a web site and viewing a web page at the web site.

A browser is a program used to view, download, upload, surf or otherwise access documents (pages) on the World Wide Web. A browser may be text-based but most browsers are text and graphical based. Browsers read “marked up” or coded pages (usually HTML but not always) that reside on servers and interpret the coding into what a person viewing sees “rendered” as a web page.

Processor subsystem 125, similarly to workstations 105, 110, 115, may be implemented on a general purpose microcomputer, such as one of the members of the Sun™ Microsystems family of computer systems, one of the members of the IBM™ Personal Computer family, or any conventional work-station or graphics computer device. Processor subsystem 125 includes a processor 130 and an associated memory 135.

Processor subsystem 125 is assigned a uniform resource locator (URL). A URL is an Internet address (for example, http://www.tanagraphics.com), usually consisting of an access protocol (http), a domain name (www.tanagraphics.com), and optionally a path to a file or resource residing on a server. In general terms, a web server is a computer that serves up web pages. Every web server has an Internet Protocol (IP) address and possibly a domain name. IP is a scheme that enables information to be routed from one network to another. For example, if a user enters the URL http://www tanagraphics.com/index.html in a browser, the browser sends a request to a server whose domain name is tanagraphics.com. The server then fetches a page named index.html and sends it to the browser. Typically, an index page is a home page of the site or a site section and includes a most general level of site or site section navigation.

Memory 135 holds data and instructions for execution by processor 130. In particular, memory 135 contains a program module that controls processor 130 to perform a method in accordance with the present invention as described herein. The program module is also known as a content management application.

Although system 100 is described herein as having the instructions for the method of the present invention installed into memory 135, the instructions can reside on an external storage media 140 for subsequent loading into memory 135. Storage media 140 can be any conventional storage media, including, but not limited to, a floppy disk, a compact disk, a magnetic tape, a read only memory, or an optical storage media. Storage media 140 could also be a random access memory, or other type of electronic storage, located on a remote storage system and coupled to memory 140.

Database 145 is a storage system coupled to processing subsystem 125. Although database 145 is shown in FIG. 1 as being directly coupled to processing subsystem 125, is could be remotely located from processing subsystem 125 and coupled thereto via network 120. Database 145 contains data relating to articles and documents that are developed by the users of system 100.

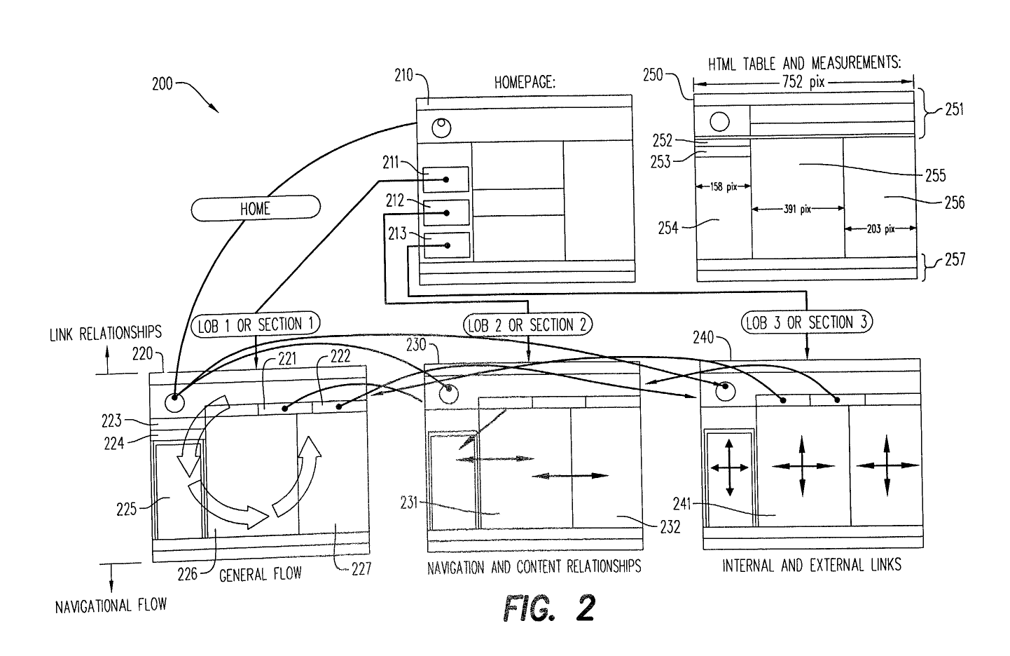

FIG. 2 shows a layout of several web pages in accordance with one embodiment of the interactive publishing system of the present invention. The several web pages include a homepage 210, a first LOB page 220, a second LOB page 230 and a third LOB page 240. Although only three LOB pages (220, 230 and 240) are represented in FIG. 2, the publishing system is not limited to any particular number thereof. The web pages each include areas designated to contain substantive content, e.g., text and images, or to provide navigation bars (nav) from a presently displayed page to another page.

A hyperlink, also referred to as a link, is a text or image area on which a user can click to “connect to” or reference another document or content component. A link can connect two web pages, i.e., an internal link, or two web sites, i.e., an external link. A text hyperlink is displayed, for example, as underlined blue text, and a graphical hyperlink is displayed, for example, as a small graphic image.

A nav is a directional tool on a web page. For example, a set of nav bars can be associated with a collection or list of names or images that are hyperlinked to other pages. Thus, nav bars guide a user through a hierarchy of linked web pages.

An LOB is a main site section. As contemplated for the present invention, an LOB is a major heading in a site's home page left navigation. In one embodiment of the present invention, each LOB has its own workflow, as represented by LOB pages 220, 230 and 240.

FIG. 2 also shows a template 250 of a suggested HTML table and measurements for the web pages. In content management and database applications, a template is a blank form that shows which fields exist, and the locations and sizes of the fields. Fields are populated by database-managed text and media that are displayed in a layout determined by the template.

A content component of an article can be any of text, a link (text based or image based), or an asset (e.g., image, sound, video, animation). An element of a template is a defined space within which a content component is rendered, i.e., positioned and displayed, or in the case of an active content component such as an audio clip, executed. A template may include a plurality of elements.

Template 250 includes areas, designated for a section navigation element 251, a search element 252, a site map element 253, a sub-section navigation element 254, a body element 255, a related navigation element 256 and footer element 257. Based on a template such as template 251, an element or an area of a web page can be made to conform to a predefined grid that specifies pixel dimensions for the element or area. Template 250 is merely exemplary, as any desired template can be employed in the present invention. Each of homepage 210 and LOB pages 220, 230 and 240 may include some or all of the areas shown in template 250.

Home page 210 is the home page of the interactive publishing system. A home page is the first page retrieved by a user when accessing a web site. There can be several distinct elements, for example, a main central body element, a search element, a top navigation element, a footer element, left nav element or LOB navigation element, and a sub-section navigation element. A top nav provides information, such as a web site logo and often top navigation buttons, that is usually repeated throughout a web site. A footer is information placed in the bottom margin of a web page and is often repeated on every page of the web site.

Home page 210 serves as a table of contents for the rest of the pages on the web site. For example, home page 210 includes a sub-section nav element (with respect to template 250, see sub-section nav element 254) that further includes nav bars 211, 212 and 213 into which a user can click to navigate to each of LOB page 220, LOB page 230 and LOB page 240, respectively.

LOB page 220 represents a first line of business. Note that its layout also conforms to that of template 250. Near its top side it has a section nav element, and within the section nav element it has a nav bar 221 that links to LOB page 230, and a nav bar 222 that links to LOB page 240. It also includes areas for a search element 223, a site map element 224, a sub-section nav element 225, a main content (body) element 226, and related nav element 227.

LOB page 220 is shown with wide arrows circulating in a counter-clockwise direction. These arrows represent a hierarchical organization of information presented to a user by LOB page 220. The most general information is presented along the top, information of a second level of generality is presented on the left side, main content is in the middle, and lower level, i.e., related content, is located along the right side. Thus, a conceptual flow of information passes from a general area to navigation area, to a left navigation sub-section, to a selected article, and to a right navigation that lists supporting content. This layout is preferred because many users intuitively scan or review a presentation in this manner. That is, a user is prone to look to the top of LOB page 220 for the most general information, and thereafter, look to the left side of a presentation for a second level of generality, etc. However, the present invention may employ any desired layout of information.

LOB page 230 is shown with several double-headed arrows. Similarly to the wide arrows shown on LOB page 220, these arrows represent a hierarchical organization of content between various areas of a web page. For example, a user who is viewing LOB page 230 will often have a tendency to regard main content in area 231 as being related to related content or navigation in area 232.

LOB page 240 is shown with several double-headed arrows, each within an individual area of LOB page 240. Each of these arrows represents a hierarchical organization of content within the area that the arrow is situated. For example, area 241 represents main content of an article, and within that main content there may be links to other parts of that main content.

In accordance with the present invention, each of the Author, Editor and Publisher have privileges and responsibilities with regard to the various areas of homepage 210 and LOB pages 220, 230 and 240. For example, with reference to LOB page 230, the Author may have a privilege to originate and insert content into area 231, whereas the Editor may thereafter accept the content or reject the content. The present invention operates to enforce such privileges and responsibilities.

The content management application enforces these privileges and responsibilities by controlling a progression of an article, or some content thereof, from the Author, to the Editor, to the Publisher and thereafter to a site for publication. For example, the Author may create content for the article, and then submit the content to the Editor. The Editor may review the content, and then either return the content to the Author, or further submit the content to the Publisher.

The terms “submit” and “return”, as used herein with respect to the progression of content and articles, do not necessarily require a physical movement of any tangible item or of an electronic copy of such item. Rather, these terms are meant to indicate a conceptual progression of the content between the workspaces of the Author, Editor and Publisher. For example, a file that contains the content may be opened and stored in database 145. The Author, Editor or Publisher can access the file, copy it into a workspace and work on the file in a manner commensurate with their individual privileges and responsibilities. Thereafter, database 145 can be updated to reflect changes to the file.

A workspace is a screen that is displayed after a user logs on to the publishing system. As contemplated for the preferred embodiment, it is a graphic user interface that displays workflow tasks and content components on which work is to be done.

Each of the Author, Editor and Publisher are granted a workspace. The workspaces, privileges and responsibilities of the Author, Editor and Publisher are described below in greater detail.

In the context of the present invention, the following terms can be defined as follows:

(1) edit: a function of changing (adding and deleting) content elements within a workspace template form;

(2) delete: a role-based or user-based function of removing a content component from a workspace and from a database record; and

(3) reject: a function of returning a content component to a user who submitted it.

An Author can create an article, add content to the article, edit the article and delete the article. The Author's workspace includes a menu of types elements that can contain content components that can be created, edited and deleted by the Author. Such elements include an article element, a right nav element, a right nav collection element, and a center nav element. Within these elements, the Author can establish or define new content, edit the content and delete the content. That is, the privilege of creating content includes privileges of adding, editing and deleting the content.

The Author can create a new article. A new article is a page, such as a web page, of information about a topic. The Author can edit an article that is returned to the Author by an Editor. The original Author of an article can edit, i.e., change, or delete such article.

The Author can create a new related nav element or right nav element. A new related nav element or right nav element is a right navigation bar that is template based and whose content components may include image, text and links. The content of the right nav element is related by meaning to the main content components of an article. The Author can edit a right nav that is returned to the Author by an Editor. The original Author of a right nav can delete such right nav.

The Author can create a new related nav or right nav collection. A new related nav or right nav collection is a right navigation bar that is template based and whose content components are groups of articles. The Author can edit the content of a collection of right nav elements that is returned to the Author by an Editor. The original Author of a right nav collection can delete such right nav collection.

A shopping cart is an application for online shopping and catalog product display. A shopping cart category is a product type listing that is selected from a table. A shopping cart category refers to a product, a shopping cart sub-category refers to a type product, and a catalog page refers to a page displaying all of a selected product type. For example:

Pants>Jeans

displays available jeans. Product associations and cross selling are used for promoting associated products to a particular product added to a shopping cart.

The Author can create a new shopping cart category. The Author can edit a shopping cart category that is returned to the Author by an Editor. The original Author of a shopping cart category can delete such shopping cart category.

The Author can create a new shopping cart sub-category. A shopping cart sub-category is a shopping cart category that is selected from a table. The Author can edit a shopping cart sub-category that is returned to the Author by an Editor. The original Author of a shopping cart sub-category can delete such shopping cart sub-category.

The Author can create a new catalog page. A catalog page is a table of products with product descriptions and product thumbnails. The Author can edit a catalog page that is returned to the Author by an Editor. The original Author of a catalog page can delete such catalog page.

The Author can create a new link collection or center nav. A new link collection or center nav is a set, for example in a horizontal arrangement, of hyperlinked images and text that increase navigation routes within a web page. The Author can edit a new link collection or center nav that is returned to the Author by an Editor. The original Author of a new link collection or center nav can delete such new link collection or center nav.

The Author has a variety of visual assets with which to work. The visual assets are offered in a menu selection that enables visual elements workflow, for example, Upload, Upload Shared, Shared Lib(rary), Image Lib(rary). These functions allow the Author to upload visual resources from offline directories and to place them in general or LOB specific image libraries.

An Editor can edit (add content to and delete content from) an article, delete an article, approve of an article, and reject an article. The Editor's workspace includes a menu of elements in which content components can be created, edited and deleted by the Editor. Such elements include Sub-Section Nav, Sub-Section Nav Collection, Index Page, and Sub-LOB. Within these elements, the Editor can establish or define new content, edit the content and delete the content.

The Editor can create a new sub-section nav. A sub-section navigation bar, which can be provided as a left nav, is template based and its elements may include hyperlinked article titles. The content of a sub-section can provide a major navigation structure for an LOB. An Editor can edit a sub-section nav that is returned to the Editor by a Publisher. An originating Editor of a sub-section nav can delete such sub-section nav.

The Editor can create a new sub-section nav collection. A sub-section collection navigation bar is a template-based collection of Left Navs. The content of the Sub-Section Collection can provide more detailed navigation structure for an LOB. An Editor can edit a sub-section nav collection that is returned to the Editor by a Publisher. An originating Editor of a sub-section nav collection can delete such sub-section nav collection.

The Editor has an exclusive privilege to create a new index. An index forms the main page of an LOB and its content components determine a main navigation structure of the LOB. An originating Editor of an index can edit such index.

The Editor can edit or delete an article that is submitted to the Editor by an Author or that is returned to the Editor from a Publisher.

The Editor can edit or delete the following items if they are submitted to the Editor from an Author:

(1) a link collection;

(2) a related nav element;

(3) a shopping cart category;

(4) a shopping cart sub-category; and

(5) a catalog page.

A compound content is a collection of similar content components. The Editor can be granted an exclusive privilege to assign a rank, e.g., a numerical rank, to the content components.

The Editor can be assigned a role of a Master Editor. A Master Editor has rights to expand the navigational hierarchy of an LOB and the workflow that supports the content management within the hierarchy.

In a suggested embodiment of the present invention, the Master Editor has a workspace with three headings, namely (1) Authors Tree, (2) Editors Tree and (3) Sub LOB Tree. These heading open the forms for creating editing, and deleting Sub LOBs and their corresponding user workflows. For example, the Master Editor can create a new Sub LOB and assign authors and editors to it. This assignment will establish email notification routes for signaling submissions or rejections. Additionally, the Master Editor has the option of moving or relocating a Sub LOB to a new position within the navigational hierarchy.

A Publisher can reject an article, outdate an article, approve an article and publish an article. The Publisher's workspace provides resources to allow the Publisher to perform responsibilities associated with his or her role. The Publisher previews an article, and thereafter, either returns the article to an appropriate Editor, or submits it to an Approve List.

The Approve List has functions associated therewith for (a) scheduling a time and date of posting content to a live site, (b) posting the content live, in real-time, and (c) rejecting the content back to the appropriate Editor. When an article is published to the live site, the article's name and metadata are displayed in a Published List. Metadata are keywords, i.e., tagging mechanisms, associated with a product. Such keywords are use for searching, product cross selling, product categorizations and product relationships.

The Published List has functions associated therewith for (a) scheduling a time and date of outdating a content component, and (b) outdating content in real-time. Outdated content is listed in an Outdated List.

The Outdated List has functions associated therewith for (a) rejecting content, and (b) returning the content to its appropriate Editor.

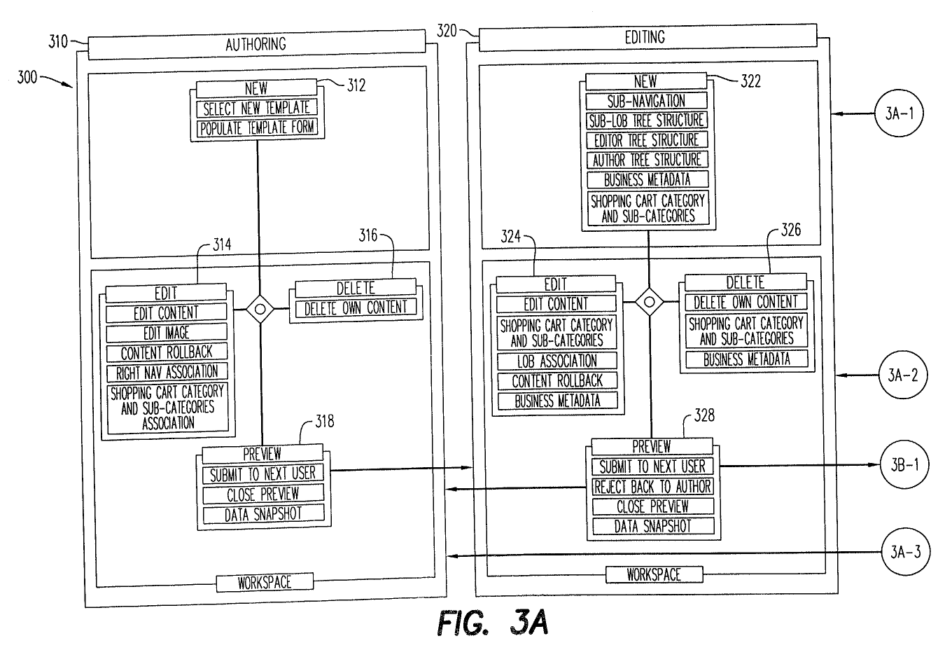

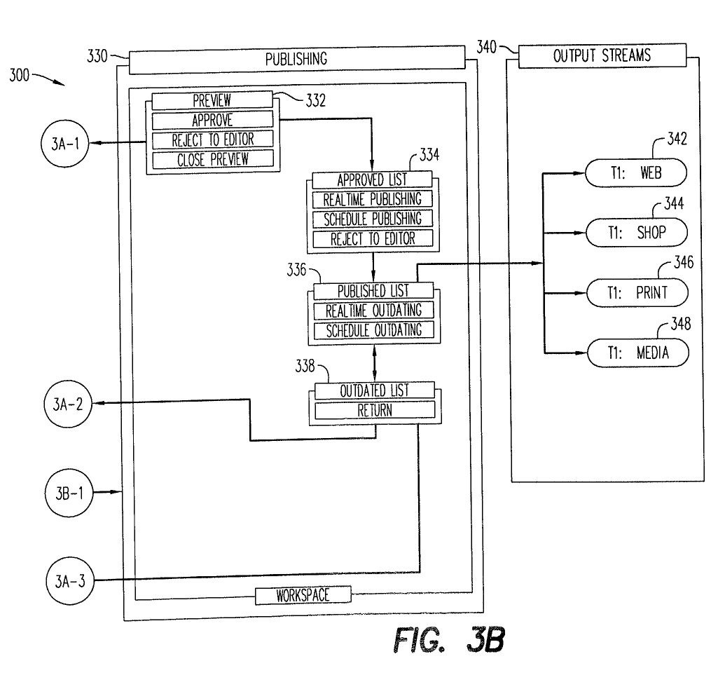

FIGS. 3A and 3B, collectively, illustrate a block diagram of the content management application, which is generally referred to with numeral 300, and a progression of workflow through the interactive publishing system of the present invention. Content management application 300 is a program module, shown here to be configured with a plurality of subordinate modules, namely an authoring module 310, an editing module 320, and a publishing module 330. FIG. 3B also shows output streams 340 to which published material can be directed.

Authoring module 310 enforces privileges and responsibilities of the Author, generally relating to adding, editing and deleting content of an article. It includes modules 312, 314, 316 and 318.

Module 312 permits the Author to create new content. For example, the Author can create templated content components and visual assets. Module 312 formats the article in accordance with a template, and the content is designated for presentation in an element of the template. The Author is permitted to select and populate the new template.

Module 314 permits the Author to edit content. For example, the Author can edit an existing content component such as an article, an image, a right nav link, a shopping cart category and a shopping cart sub-category.

Module 316 permits the Author to delete content. Preferably, such permission is granted only for content that was originated by the Author.

Module 318 permits the Author to preview the content, and to submit the content to the next user, i.e., the Editor. In FIG. 3A, the submission of the content from the Author to the Editor is represented by an arrow directed from module 318 to Editing module 320.

Editing module 320 enforces privileges and responsibilities of the Editor, generally relating to adding, editing and deleting the content. It includes modules 322, 324, 326 and 328.

Module 322 permits the Editor to create new content. For example, the Editor can create (a) a new templated sub section navigation, (b) a new sub section navigation structures from tree tables that depict LOB and sub-LOB hierarchy, and assign new content users and user groups for the new sub-LOBs, (c) a new shopping cart category and (d) a new shopping cart sub-category. The Editor can also create business metadata such as general product typographies that are broad enough to link existing shopping cart categories with related products. These product associations will be used for cross selling.

Module 324 permits the Editor to edit content. For example, the Editor can edit LOB navigation, sub LOB navigation, shopping cart categories and subcategories, and business metadata.

Module 326 permits the Editor to delete content. Preferably, such permission is granted only for content the Editor originated.

Module 328 permits the Editor to preview content, and to either (a) return the content to Author, preferably the Author that originated the content, or (b) submit the content to the next user, i.e., the Publisher. The content submitted to the Publisher may include a shopping cart category, a shopping cart sub-category and business metadata. In FIG. 3A, the return of the content from the Editor to the Author is represented by an arrow directed from module 328 to Authoring module 310, and the submission of content from the Editor to the Publisher is represented by an arrow directed from module 328 to Publishing module 330.

Publishing module 330 enforces privileges and responsibilities of the Publisher, generally relating to a rejection of the content, or an approval of the content for publishing. It includes modules 332,334, 336 and 338.

Module 332 permits the Publisher to preview content, and to either (a) reject the content and return it to the Publisher, preferably the Publisher that submitted the content, or (b) approve of the content for publishing. In FIG. 3B, the return of the content from the Publisher to the Editor is represented by an arrow directed from module 332 to Editing module 320, and the approval is represented by an arrow directed from module 332 to module 334.

Module 334 responds to the Publisher's approval of the content by assigning the content to an Approved List. From the Approved List, the Publisher can select for the content to be (a) published in real-time, i.e., immediately, or (b) scheduled for subsequent publication. Published content is listed in a Published List, i.e., module 336.

Module 336 provides the Publisher with the Published List and permits the Publisher to further manage the publishing of content. From module 336, the content can be dispatched or directed to an appropriate one or more of output streams 340.

Module 336 permits the Publisher to select content for outdating, that is for “unpublishing” or removal from publication. In the context of a website, outdating implies removal of content from the website. The Editor can outdate the content in real-time, i.e., immediately, or schedule the outdating to occur at some future time. Outdated content is placed onto an Outdated List, i.e., module 338.

Module 338 permits the Publisher to either (a) expire content and send it back to either the Editor or the Author, or (b) retain the outdated material for subsequent republication. To “expire” an article is to remove it from a website but not from the Publisher's workspace. Such expiration applies only to a previously published article. The Publisher is the only agent that has the ability to expire published pages. Republication is useful, for example, in a case where a special sale is advertised only during the first week of each month, and therefore the Publisher re-publishes a sale flyer the first week of each month. In FIG. 3B, the return of outdated content is represented by an arrow directed from module 338 to Editing module 320 and to Authoring module 310, and the re-publication of outdated material is represented by a double-headed arrow between modules 336 and 338.

Output streams 340 provide several possible cross-media output destinations to which the content can be directed. These include a web site 342, a shopping cart 344, a print module 346 and a media repository 348.

Web site 342 can be either an Internet web site, and intranet web site or an extranet web site. A web site is a set of interconnected web pages, usually including a homepage, generally located on the same server, and prepared and maintained by a workflow. An intranet website is a set of interconnected web pages in a privately maintained computer network that can be accessed only by authorized persons, especially members or employees of the organization that owns it. An extranet website is a set of interconnected web pages that are an extension of an institution's intranet, especially over the World Wide Web, enabling communication between the institution and people it deals with, often by providing limited access to its intranet.

Shopping cart 344 is an application for online shopping and catalog product display. An electronic shopping cart as found in the Web can also be categorized as virtual store. A transaction is done online. A catalog of products is presented to a customer. The customer can click to a particular product to see more detail or can add the product directly to a shopping cart. The shopping cart, analogous to a real-life counterpart, “holds”, e.g., lists, the products while the customer continues to shop. The customer “moves” the cart to a checkout when the customer is ready to buy the products.

Print module 346 is for producing a hard copy of the published material. It can include, for example, a browser-based application for creating print on demand marketing and business communications.

Media repository 348 is a data asset repository from which published material can be drawn by other users. It can include, for example, a digital asset management application for storing, searching, previewing and distributing media assets.

Thus, with reference to FIGS. 1 through 3A and 3B, system 100 operates as a publishing system for managing content of an article through execution of content management application 300. Processor subsystem 125 executes the content management application residing in memory 135. The Author, Editor and Publisher access processor subsystem 125 via a browser from workstations 105, 110 and 115 and interactively engage with the content management application. Processor subsystem 125 includes:

(1) an authoring module 310 for permitting an author to

(a) create the content, and

(b) submit the content to an editor;

(2) an editing module 320 for permitting the editor to

(a) edit the content, and

(b) selectively

(i) return the content to the author, or

(ii) submit the content to a publisher; and

(3) a publishing module 330 for permitting the publisher to selectively

(a) reject the content, or

(b) approve of the content for publication.

As mentioned earlier, module 312 formats the article in accordance with a template. Such a template can have a first element, e.g., a body element, and a second element, e.g., a sub-section nav element. Authoring module 310 permits the author to create a first portion of the content in the first element, and editing module 320 permits the editor to create a second portion of the content in the second element. For example, the article can be a web page, and in the body element the Author can create narrative text with a first hyperlink to a first related article, and in the sub-section nav element the editor can create a hyperlink to a second related article.

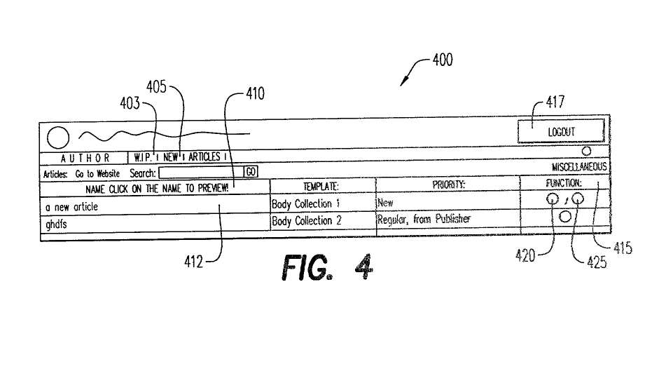

FIGS. 4 through 17 show suggested layouts for various screens and workspaces for an embodiment of the present invention that was developed by Tanagraphics, Inc. of New York, N.Y. The description of FIGS. 4 through 7 provides a further details of the manner in which the content management application enforces the privileges and responsibilities of the Author, Editor and Publisher.

Some of the features of the content management application are:

(a) a collaborative creation of static and dynamic web pages;

(b) a setting of specific workflow roles and responsibilities for creating and delivering content;

(c) a previewing and testing of content revisions; and

(d) a regulation of consistent design and deployment procedures through template based layout and a merging of content fields into dynamically assembled web pages.

The Author has an exclusive privilege to originate articles and content. The Author may also create and associate a right navigation bar to an article, and the Author may create a central navigation bar. Once the authoring process is completed, the Author forwards the content to the Editor for review and approval.

The Editor may either edit or reject and return an article to the Author for rewriting. Like the Author, the Editor may also create and attach a right navigation bar to an article. The Editor has the exclusive privilege to create a left navigation bar. The Editor can edit an article, and the article will remain in the same workspace until the Editor decides to forward the article to the Publisher or reject the article to the Author. The Editor forwards approved content to the Publisher for review.

The Publisher may either approve and publish the article or reject and return it to the Author or Editor for rewriting or re-editing. The Publisher has no role in the editing of articles and navigation bars, but the Publisher may reject a left nav and left nav collection and send them to the Editor. The Publisher may also reject a right nav, right nav collection and a center nav, and return them to either the Author or the Editor. The Publisher has an exclusive privilege to set an order and rank of home page articles and the Publisher alone has a privilege to expire a published article. In a case of expiring an article, the Publisher may send the article to either the Editor or the Author for updating or revision.

A user accesses the content management application via a user workstation, e.g., one of workstations 305, 310 or 315. The user opens an internet browser, navigates to a user resource locator (URL) to commence a user session, and logs into the session by providing a username and password.

The user's access privileges as an Author, Editor or Publisher are associated with the username. Accordingly, based on the access privileges, the user will be presented with one of an author workspace, an editor workspace or a publisher workspace. Exemplary workspaces for each the Author, Editor and Publisher are described below.

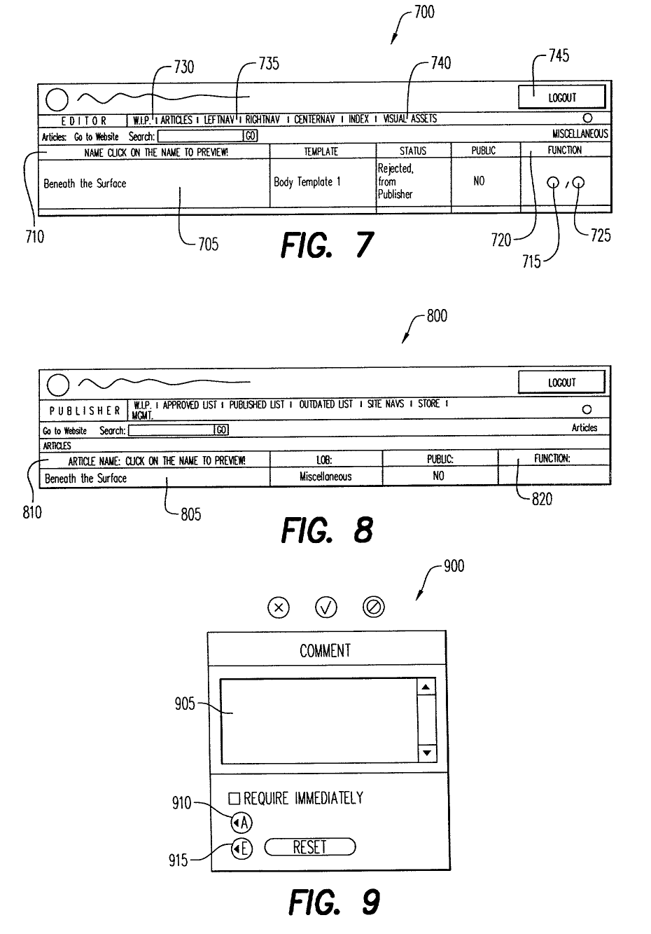

Within the Author workspace or Editor workspace (see FIGS. 4 and 7, respectively), which display workflow tasks and items to be worked on, each item has a listed columnar set of properties. The properties may include, for example:

(1) Name: a item's ID;

(2) Template: template type ID;

(3) Status: an item's position within the workflow;

(4) Function: available workflow tasks: edit or delete;

(5) Shared: (not shown) a ‘Y/N’ designation that indicates whether an item is LOB specific or common to all LOBs;

(6) User: (not shown) a designation of who forwarded an item to a workspace; and

(7) Date: (not shown)The latest version date for an item.

FIG. 4 is an illustration of an exemplary author workspace 400. Via author workspace 400, the user may engage in a variety of authoring activities, several of which are described below.

1. To Create a New Article:

Point and click the New button 405. A New button, such as New button 405 is a menu selection that prompts the creation of a new content component.

2. To Edit an Article:

Identify the article's page name 412 in the Name column 410 and click the corresponding edit button 420 in the Function column 415.

3. To Delete an Article:

Identify the article's page name 412 in the Name column 410 and click the corresponding del button 425 in the Function column 415.

4. To View an Article:

Point and click the page name 412 in the Names column 410.

5. To View a List of Articles:

Point and click the W.I.P. (works in progress) button 403. W.I.P. is a list of all content components that are currently in a workflow user's workspace.

6. To Logout:

Point and click the logout button 417.

For example, a user wishing to create a new document would log on as an Author and, via author workspace 400, click on new button 405. Thereafter, the content management application displays a collection of layout templates from which the Author can make a selection.

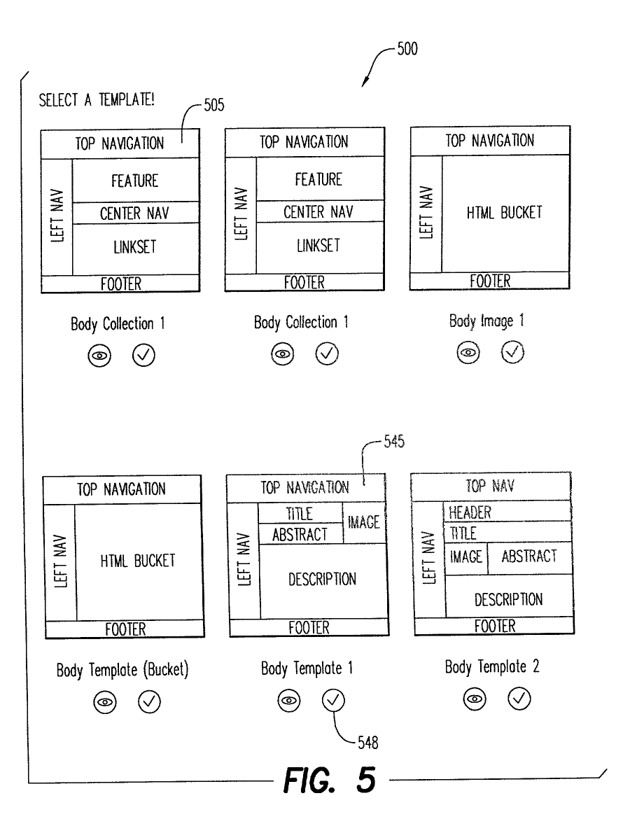

FIG. 5 shows a set 500 of several exemplary layout templates. For example, a template 505 designated as “Body Collection 1” includes areas for top navigation, left nav, feature, center nav linkset and footer. A template 545 designated as “Body Template 1” includes areas for top navigation, left nav, title, abstract, image, description and footer. The Author may select template 545 by clicking on its corresponding check mark button 548. Thereafter, the content management application presents a template form to the Author.

After the Author selects a new template, there are several template form fields into which data is entered. These fields may include, for example, in the case of an article:

(1) Name: a form field for entering the article's ID (i.e., database ID);

(2) Title: a form field for entering the article's title (e.g., as appears on a web page at the top of the article);

(3) Keyword: a form field for entering key terms that in both site search and search engine database management systems identify specific web pages;

(4) Abstract: a form field for entering a sub-header or short description of main content;

(5) Image1: a browse field for entering an image from a Visual Assets library;

(6) ImageLink1: a browse field for linking an image to an article or for creating an external link to a URL;

(7) Image credit: a form field for entering image credit information;

(8) Description: a form field for entering article content;

(9) Rank: a part of a collection form field for setting an order in which hyperlinked items (both articles and navigation content components) are displayed;

(10) Template: a form field for selecting a template layout of a content component;

(11) LOB: a form field for selecting a particular LOB of a content component in progress;

(12) Right Nav: a form field for selecting a published right navigation bar too associate with main content of a content component in progress;

(13) Auto Link: a check box for enabling an article Title to appear as a hyperlink in a main navigation bar of an LOB; and

(14) Rollback: a hyperlink that activates a Data Snapshot for version control. A Data Snapshot is a popup window that lists by Title and Date the versions of a content component and allows for previewing and selection of a version for rollback.

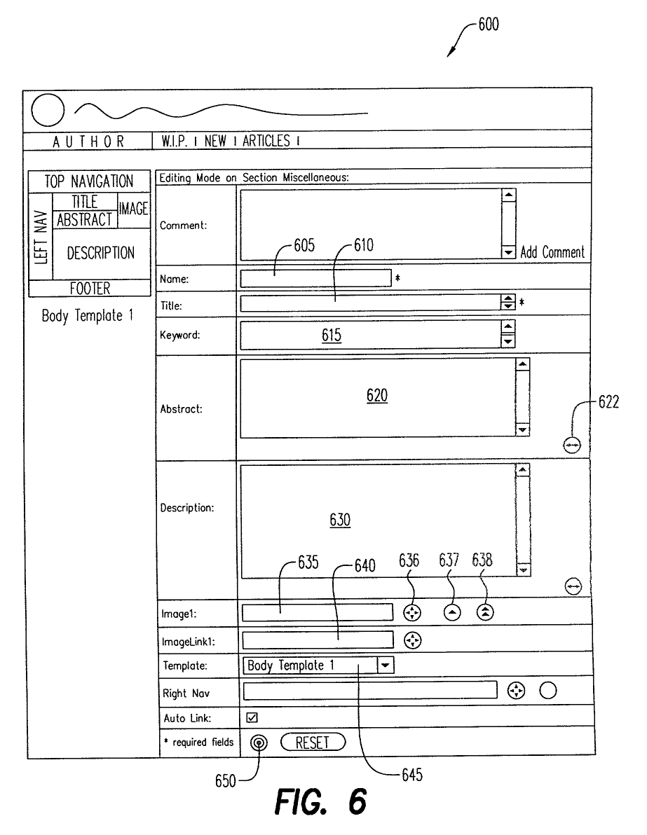

FIG. 6 is an exemplary template form 600, which in this example, is used in conjunction with “Body Template 1.” Template form 600 includes fields for text and images that are populated by the Author. The fields play various roles during communication through web pages.

1. A Name field 605 is for the article name or page name.

2. A Title field 610 is for the article title.

3. A Keyword field 615 is for a set of keywords for the article which, when encountered by a search engines on the web, will be used to categorize the document.

4. An Abstract field 620 is for an abstract of the article, for example, in the form of one or two paragraphs. In Abstract field 620, the Author may include a link, e.g., hyperlink, to another article. To insert such a link, the Author clicks on a Link button 622, and a screen is displayed that allows the Author to navigate to a target article in an article archive. The Author may preview a potential target article or select a particular target article by pointing to and clicking an appropriate control button, e.g. PREVIEW and SELECT, respectively. For example:

The Movies PREVIEW SELECT

The Olympic Games PREVIEW SELECT

A link tag is displayed at the bottom of Abstract field 620. The Author can highlight and move this tag to a desired location. Additionally, or in the alternative, the Author can use an HTML tag to provide the link.

5. A Description field 630 is for the body of the article. In Description field 630, the Author may include a link to another article, in a manner as described above for Abstract field 620.

6. Image1 field 635 is for placing an asset in the article. The Author uses a Browse button 636 to select and an asset from an asset library, and a filename of the asset appears in image1 filed 635. Although “Body Template 1” designates only one area for an asset, depending on the template used, an article can have one or more assets, or need not include any assets. Uploading an asset means to save the asset from the Author's desktop to the asset library. To upload a new asset into an Author's presently assigned LOB, the Author clicks an Upload button 637, which opens a dialog box that enables the Author to effectuate the upload. The Author may share an asset across multiple sections or LOBs. To upload an asset that can be shared/used by other sections, the Author clicks an Upload in Common button 638, which opens a dialog box that enables the Author to effectuate the upload to a common, i.e., shared, asset library.

7. The Image Link field 640 is for placing a link in the image. The Author may use a Link button to select the link.

8. Template field 645 identifies the selected type of template.

After filling in the fields in template form 600, the Author clicks Submit button 650 to save the article, and the content management application displays the Author's workspace (see FIG. 4).

Referring again FIG. 4, the Author can preview the article by clicking on the article's name in name column 410. The content management application then displays the images and text arranged in the layout of the selected template, e.g., Body Template 1. When the Author is finished with the article, the Author can forward the article to the Editor by clicking a Submit to Editor button (not shown in FIG. 4) or edit the article by clicking on an edit button (not shown) and returning to template form 600 (FIG. 6). If the Author wishes to take no further action at this time, the Author can click on a close button (not shown) to save the article in its current state.

FIG. 7 is an illustration of an exemplary editor workspace 700. Via editor workspace 700, the user may engage in a variety of editing activities, several of which are described below.

1. To Edit an Article:

Identify the article's page name 705 in the Name column 710 and click the corresponding edit button 715 in the Function column 720. The Editor can also decide whether to make the article available to other sections as a linking page by marking a Share and Make Public field (not shown in FIG. 7).

2. To Reject an Article:

To reject an article, the Editor must first preview the article by clicking on the article's page name 705 in the Name column 710. A preview screen is displayed (not shown) where the content management application displays the images and text arranged in the layout of the selected template, e.g., Body Template 1. The Editor can forward the article to the Publisher by clicking a Submit to Publisher button (not shown) or edit the article by clicking on an edit button (not shown), reject the article to the Author by clicking on a Reject to Author button (not shown), or close the article. When the Editor clicks on the Reject to Author button, the content management application opens a text box (similar to FIG. 9) so the Editor can provide instructions to the Author. The instruction is emailed to the Author.

3. To View an Article:

Point and click the page name 705 on the Name column 710. A preview screen is displayed (not shown) where the Editor forwards the finished product to the Publisher by clicking a Submit to Publisher button.

4. To View a List of Articles:

Point and click the W.I.P. (works in progress) button 730.

5. To Create a Left Navigation:

Point and click the left nav button 735.

6. To manage a collection of images in an image library:

Point and click the visual assets button 740.

7. After completing editorial functions:

Click a submit button (not shown in FIG. 7) to view the edited article. At this point the article is laid out in accordance with the template that the Author used to create the article.

8. To forward the edited article to the Publisher:

Click on a Submit to Publisher button (not shown in FIG. 7).

9. To reject the article and return to its Author:

Click a reject button (not shown in FIG. 7).

10. To delete an article:

The Editor clicks on a delete button 725 adjacent to the name of the article that the Editor wishes to delete.

11. To Logout:

Point and click the logout button 745.

FIG. 8 is an illustration of an exemplary publisher workspace 800. Via publisher workspace 800, the user may engage in a variety of publishing activities, several of which are described below.

1. To View an Article:

Point and click the page name 805 in the Article Name column 810.

2. To View the List of Articles:

Point and click the W.I.P. button 815.

3. To Reject an Article:

Click the article's page name 805 in the Name column 810. The article as crafted will be displayed (not shown). At the base of the article there is a reject button that opens a comment box with an option to return the article to either the Author or the Editor. FIG. 9 is an illustration of a comment box 900. Comment box 900 includes a field 905 where the Publisher may insert an instruction. Upon clicking a Reject to Author button 910 or a Reject to Editor button 915 the instruction is emailed to either the Author or the Editor, respectively. The article is sent to the appropriate workspace.

4. To Approve and Publish an Article:

Click on the article's page name 805 in the Name column 810 to open and preview the article.

Although not illustrated herein, the article will be displayed. At the base of the article there is an approve button that the Publisher can select to approve the article. This action transfers the article to an approved status in an approved list. The Publisher can click an approved list button to view the article. At this point the Publisher can still decide whether to publish the article or to reject it back to the Author or the Editor. To publish the article and send it to a live site, the Publisher clicks a publish button or similar icon at the base of the article.

A complete listing of published articles can be viewed by clicking a published list button or icon. A published article's page name will automatically appear on the left navigation bar of its section or Line of Business (LOB).

FIG. 8 includes a function column 820. Although not illustrated herein, function column 820 includes an expire button and a reject button. The Publisher can either expire or reject an article by clicking on its corresponding expire button or reject button, respectively. The Publisher can click on an expertly list button (not shown) to view a list of expired articles.

The Author or the Editor can change an article's layout from one template to another (see FIG. 5). With reference to FIG. 4, the Author effectuates a change of layout, by opening the article by pointing and clicking edit button 420 in the Function column 415. A template field is displayed from which the Author can select a new template. The Author then clicks on a submit button (not shown) to save the new template. The Author can thereafter open the article again and enter any required changes, and click a submit button to save the changed article. Alternatively, with reference to FIG. 6, the Author can select a new template using template field 645. The Editor can effectuate a change of template in a similar manner.

A right nav holds related subjects or links to a current page view but user can add any articles, whether the article is related or not, to the right nav. A related article could be editorially related to the main page that's being viewed. The difference between adding and creating is that a user creates before the user can add. Adding a right nav means, adding a pre-defined right nav to an article. Creating is defining the content of the right nav element. Either of the Author or the Editor can add a right nav to a document or create a new nav for a document. A technique for adding a right nav and a technique for creating a new right nav are described below.

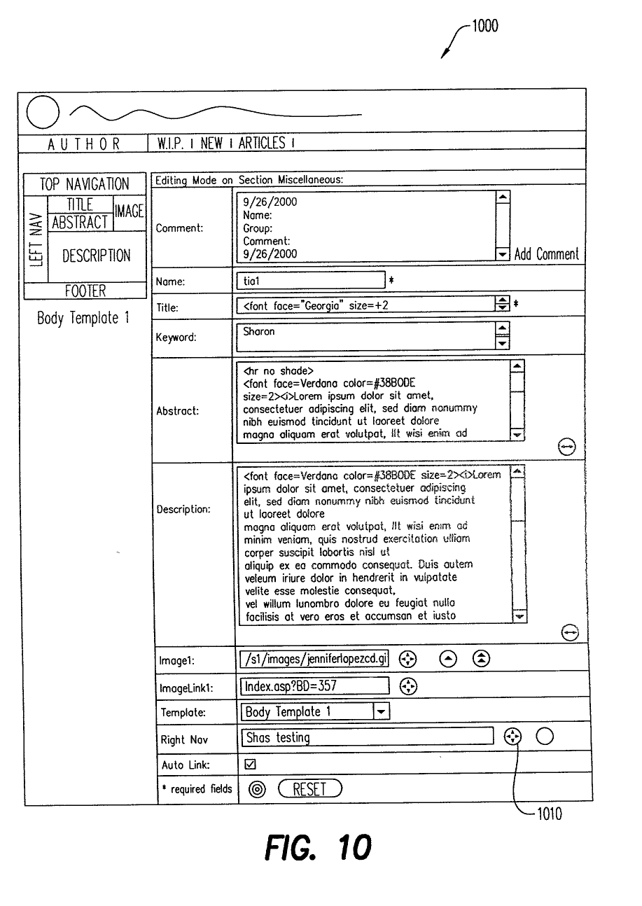

FIG. 10 is an illustration of a template form 1000 that includes content in several of its fields. The user points and clicks on a Right Nav browse button 1010 to list available right navigation related articles, and selects a related article that will appear in a right nav element of the article represented in FIG. 10.

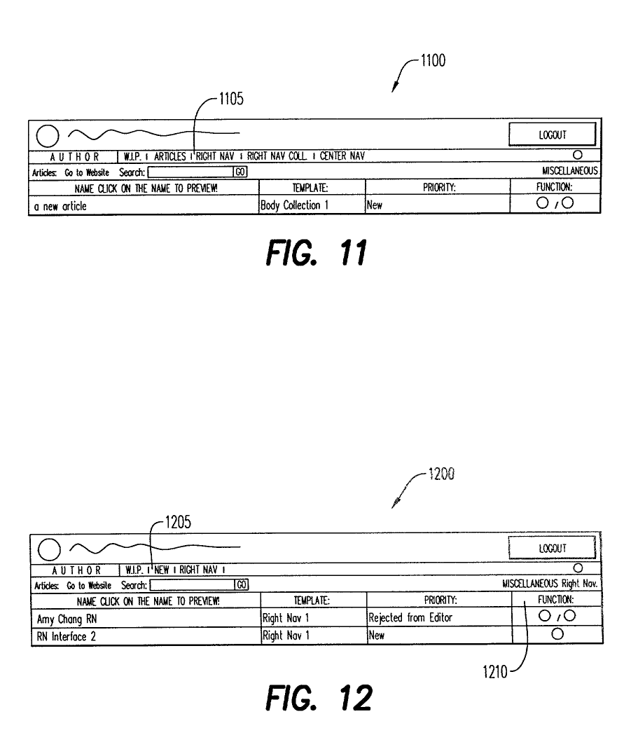

FIG. 11 is an illustration of author workspace 1100, similar to that shown in FIG. 4, which is being used here to show a technique for a user to create a new right nav. The user clicks on a Right Nav button 1105. The content management application responds by displaying a Right Nav workspace.

FIG. 12 is an illustration of a Right Nav workspace 1200. To proceed with the creation of a new right nav, the user clicks on a new button 1205. The content management application displays a template selection page (see FIG. 5) from which the user selects a template. Thereafter, a right nav interface is displayed.

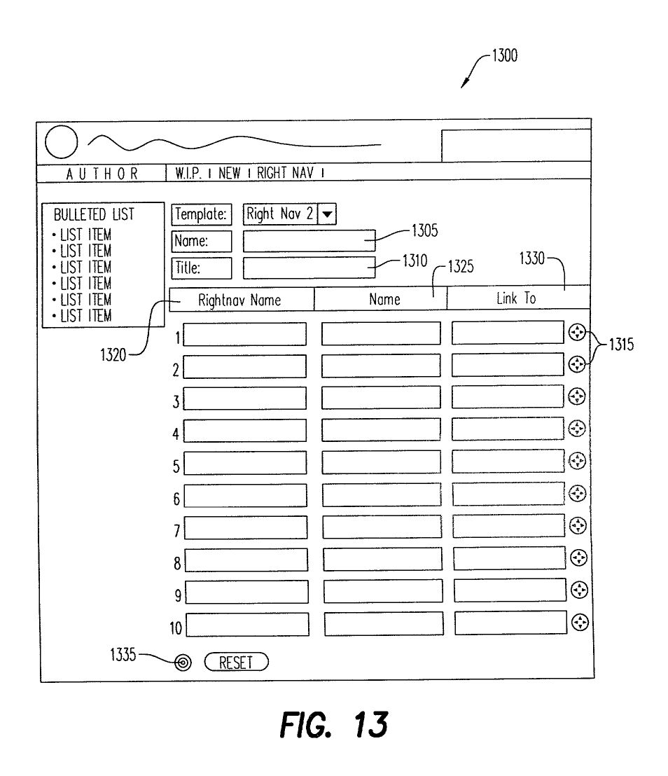

FIG. 13 is an illustration of a right nav interface 1300. To proceed with the creation of a new right nav, the user enters text in a Name field 1305 and a Title field 1310. The user clicks the Browse buttons 1315 to select/list linked content for the right nav. The user can edit or change titles in the Rightnav Name column 1320, Name column 1325 and Link To column 1330. The user clicks a Submit button 1335 to save the right nav article. After clicking Submit button 1335 the right nav workspace 1200 (see FIG. 12) is re-displayed.

Referring again to FIG. 12, to proceed with the creation of the new nav, the user points and clicks a select button (not shown in FIG. 12) in Function column 1210 to attach the right nav to the article. Thereafter, the content management application displays the article template, and the user clicks a submit button (not shown) to save the article with the new right nav.

A left nav is a collection of article links. A left nav collection is a collection of left navs with their own collections of article links. A left nav operates only within its section or Line of Business (LOB). Within sections there can be any number of left navs.

In the embodiment of the content management application being described herein, only the Editor can create a left navigation bar and a collection of left navigation bars. However, in general, any of the Author, Editor and Publisher can be permitted to create a navigation bar, and a collection thereof, that can be positioned in any part of the document.

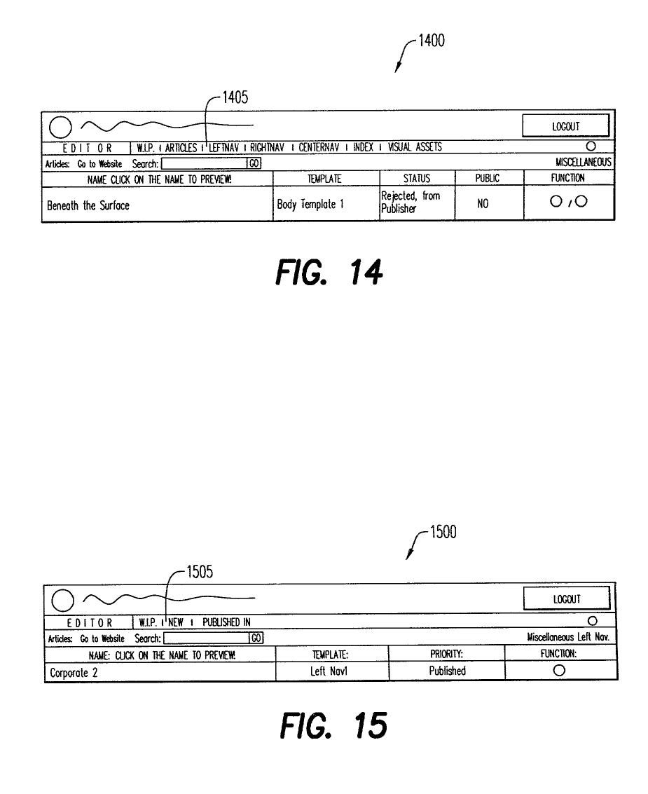

FIG. 14 is an illustration of an editor workspace 1400, similar to that shown in FIG. 7, which is being used here to show a technique for creating a new left nav. The Editor begins by clicking on a Left Nav button 1405. The content management application responds by displaying a Left Nav workspace.

FIG. 15 is an illustration of a Left Nav workspace 1500. To proceed with the creation of a new left nav, the Editor clicks on a new button 1505. The content management application displays a left nav template selection page.

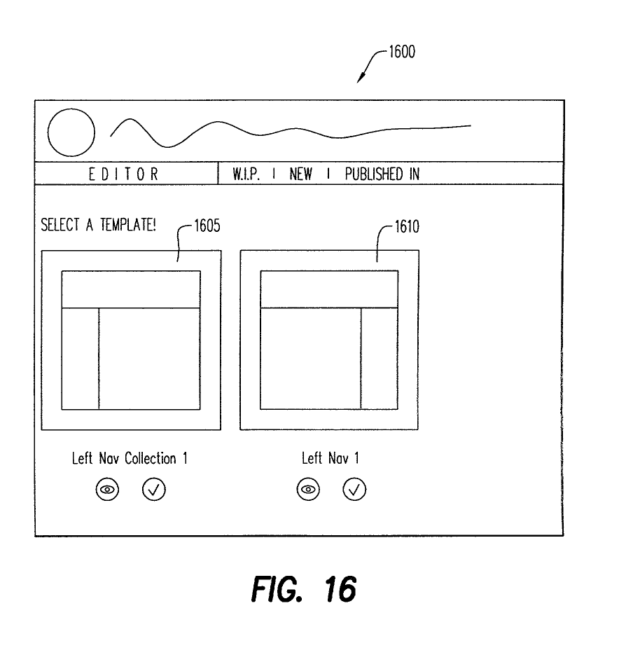

FIG. 16 is an illustration of a left nav template selection page 1600. Left nav template selection page is shown to include two templates, namely a Left Nav Collection 1 template 1605 and a Left Nav template 1610, however, any desired number and configuration of templates can be included. The Editor selects one of templates 1605 or 1610, and thereafter the content management application displays a left nav interface.

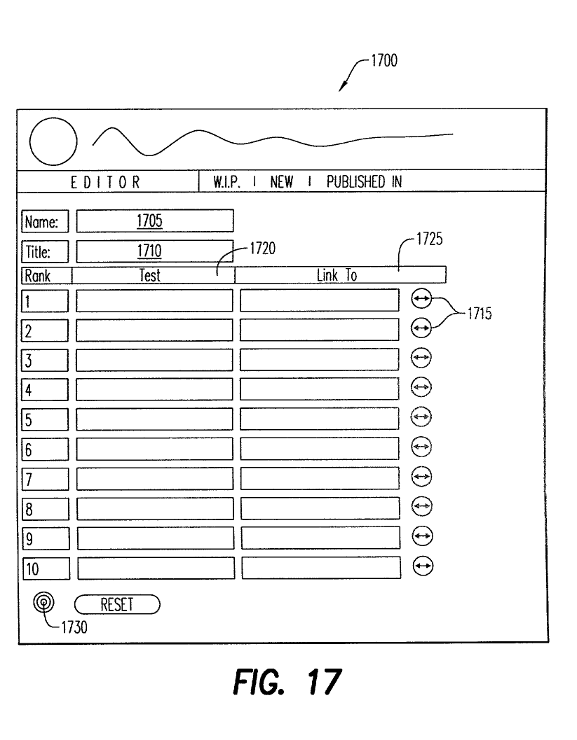

FIG. 17 is an illustration of a left nav interface 1700. To proceed with the creation of a new left nav, the Editor enters text in a Name field 1705 and a Title field 1710. The Editor clicks the Browse buttons 1715 to select/list linked content for the left nav. The Editor can edit or change titles in the Text column 1720 and Link To column 1725. The Editor clicks a Submit button 1730 to save. After clicking Submit button 1730 the left nav workspace 1500 (see FIG. 15) is redisplayed. In this manner, the Editor can create any desired number of left navigations. After having completed the left navs, the Editor clicks on a submit button (not shown in FIG. 15) to submit the document to the Publisher.

Note that Publisher workspace 800 is similar in format to that of the Author workspace 400 and the Editor workspace 700. In the Publisher workspace, the Publisher clicks a new left nav name in a Name column. After reviewing an article, the Publisher either submits to approve by clicking a submit to approve button (not shown) or rejects by clicking a reject button (not shown).

A left nav can become a center nav for a homepage. Such a center nav is created by using the same procedure as for the left nav, but the content is preprogrammed to display in a different layout. If desired, the content management application can be designed so that a center nav is only permitted for the homepage.

It should be understood that various alternatives and modifications could be devised by those skilled in the art, and the present invention can be applied to publishing systems other than type described herein. The present invention is intended to embrace all such alternatives, modifications and variances that fall within the scope of the appended claims.

What is claimed is:

1. A publishing system for managing content of an article, comprising:
a module for permitting an author to
(a) create said content, and
(b) submit said content to an editor;
a module for permitting said editor to
(a) edit said content, and
(b) selectively
(i) return said content to said author, or
(ii) submit said content to a publisher; and
a module for permitting said publisher to selectively
(a) reject said content, or
(b) approve of said content for publication.

2. The publishing system of claim 1, further comprising a module for formatting said article in accordance with a template, wherein said content is designated for presentation in an element of said template.

3. The publishing system of claim 1, further comprising a module for formatting said article in accordance with a template having a first element and a second element,
wherein said permitting said author to create said content comprises
permitting said author to create a first portion of said content in said first element, and wherein said permitting said editor to create said content comprises
permitting said editor to create a second portion of said content in said second element.

4. The publishing system of claim 1, wherein said permitting said author to create said content comprises permitting said author to add, modify and delete said content.

5. The publishing system of claim 1,
wherein said article comprises a web page, and
wherein said permitting said author to create said content comprises
permitting said author to create a navigational content component on said web page.

6. The publishing system of claim 1, further comprising a module for formatting said article in accordance with a template having a first element and a second element,
wherein said article comprises a web page that conforms to said template,
wherein said permitting said author to create said content comprises
permitting said author to create a first navigational content component in said first element, and
wherein said permitting said editor to create said content comprises
permitting said editor to create a second navigational content component in said second element.

7. The publishing system of claim 1, further comprising a module for dispatching said content to an output selected from the group consisting of a web site, a shopping cart, a print module and a media repository, after said publisher approves of said content for publication.

8. A publishing system for managing content of a web page, comprising:
a module for formatting said web page in accordance with a template having
a first element and a second element,
a module for permitting an author to
(a) create a first portion of said content for said first element, and
(b) submit said first portion of said content to an editor;
a module for permitting said editor to
(a) edit said first portion of said content,
(b) create a second portion of said content in said second element, and
(c) selectively
(i) return said first portion of said content to said author, or
(ii) submit said first and second portions of said content to a publisher; and
a module for permitting said publisher to selectively
(a) reject said content, or
(b) approve of said content for publication.

9. The publishing system of claim 8, wherein said permitting said author to create a first portion of said content comprises permitting said author to create a navigational content component in said first element.

10. The publishing system of claim 8, further comprising a module for dispatching said content to an output selected from the group consisting of a web site, a shopping cart, a print module and a media repository, after said publisher approves of said content for publication.

11. A storage media having instructions for controlling a processor in a publishing system for managing content of an article, said storage media comprising:
a module for permitting an author to
(a) create said content, and
(b) submit said content to an editor;
a module for permitting said editor to
(a) edit said content, and
(b) selectively
(i) return said content to said author, or
(ii) submit said content to a publisher; and
a module for permitting said publisher to selectively
(a) reject said content, or
(b) approve of said content for publication.

12. The storage media of claim 11, further comprising a module for formatting said article in accordance with a template, wherein said content is designated for presentation in a element of said template.

13. The storage media of claim 11, further comprising a module for formatting said article in accordance with a template having a first element and a second element,
wherein said permitting said author to create said content comprises
permitting said author to create a first portion of said content in said first element, and
wherein said permitting said editor to create said content comprises
permitting said editor to create a second portion of said content in said second element.

14. The storage media of claim 11, wherein said permitting said author to create said content comprises permitting said author to add, modify and delete said content.

15. The storage media of claim 11,
wherein said article comprises a web page, and
wherein said permitting said author to create said content comprises
permitting said author to create a navigational content component on said web page.

16. The storage media of claim 11, further comprising a module for formatting said article in accordance with a template having a first element and a second element,
wherein said article comprises a web page that conforms to said template,
wherein said permitting said author to create said content comprises
permitting said author to create a first navigational content component in said first element, and wherein said permitting said editor to create said content comprises permitting said editor to create a second navigational content component in said second element.

17. The storage media of claim 11, further comprising a module for dispatching said content to an output selected from the group consisting of a web site, a shopping cart, a print module and a media repository, after said publisher approves of said content for publication.

18. A storage media having instructions for controlling a processor in a publishing system for managing content of a web page, said storage media comprising:
a module for formatting said web page in accordance with a template having
a first element and a second element,
a module for permitting an author to
(a) create a first portion of said content for said first element, and
(b) submit said first portion of said content to an editor;
a module for permitting said editor to
(a) edit said first portion of said content,
(b) create a second portion of said content in said second element, and
(c) selectively
(i) return said first portion of said content to said author, or
(ii) submit said first and second portions of said content to a publisher; and
a module for permitting said publisher to selectively
(a) reject said content, or (b) approve of said content for publication.

19. The storage media of claim 18, wherein said permitting said author to create a first portion of said content comprises permitting said author to create a navigational content component in said first element.

20. The storage media of claim 18, further comprising a module for dispatching said content to an output selected from the group consisting of a web site, a shopping cart, a print module and a media repository, after said publisher approves of said content for publication.
